(19) United States
(12) Patent Application Publication
(10) Pub. No.: US 2013/0112048 A1
(43) Pub. Date: May 9, 2013

(54) Screwdriver

(71) Applicant: Jack LIN, Taichung City (TW)

(72) Inventor: Jack LIN, Taichung City (TW)

(21) Appl. No.: 13/288,710

(22) Filed: Nov. 3, 2011

(51) Int. Cl. B25B 15/04

(52) U.S. Cl. 81/63.1

(57) ABSTRACT

A screwdriver-used torque transmission apparatus includes a frame including a slot, an aperture and four cavities. The slot is in communication with the aperture and cavities. A gear includes a non-circular aperture axially defined therein, teeth formed on a side thereof, and teeth formed on an opposite end thereof. The gear is located in the slot. A pawl formed with at least one tooth and a block is located in each of the cavities. A shell includes two pushers formed on an internal side thereof. The shell is rotationally provided around the frame between two one-way modes in each of which a related one of the pushers pushes the blocks of two related ones of the pawls to disengage the teeth of the two pawls from the teeth of the gear.

### BACKGROUND OF INVENTION

1. Field of Invention

The present invention relates to a screwdriver and, more particularly, to an apparatus for transmitting torque to and a bit from a handle in a screwdriver.

2. Related Prior Art

There have been various hand tools. For example, screwdrivers or spanners are often used to drive screws or nuts.

As disclosed in Taiwanese Patent Publication No. 17440, a conventional screwdriver includes a bit 1, handle 2 and a ring 3. The bit 1 includes two different operative tips. A selected one of the operative tips of the bit 1 is located outside the handle 2 while the unselected operative tip of the bit 1 is inserted in the handle 2. The ring 3 is engaged with the handle 2 to retain the unselected operative tip of the bit 1 in the handle 2. A user engages the selected operative tip of the bit 1 with a screw and then rotates the selected operative tip of the bit 1 in a first direction to rotate the screw in the first direction. Then, the user disengages the selected operative tip of the bit 1 from screw and then rotates the selected operative tip of the bit 1 in a second direction opposite to the first direction without rotating the screw in the second direction. The process is repeated so that the screw is tightened in or removed from a work-piece. The process is however inconvenient.

As disclosed in Chinese Utility Model Patent No. 201625945, another conventional screwdriver includes a shaft 1 formed with a gear 12 near a rear end. The gear 12 is inserted in a frame 21 through a ring 7 before the ring 7 is engaged with the frame 21 to tighten a cap 3 on the frame 21 to cause a control strip 6 to close a recess 25 defined in the frame 21. The control strip 6 includes two bosses 61 for supporting two springs 5 for biasing two locks 41 and 42 in the recess 25. Each of the locks 41 and 42 includes a wide end in contact with a related one of the springs 5 and a narrow end inserted in an arched groove 32 defined in the cap 3. The cap 3 an be rotated around the gear 12 so that the wall of the arched groove 32 pushes the narrow end of the lock 41 for example to disengage the wide end of the lock 41 from the gear 12 but engage with the wide end of the lock 42 with the gear 12. However, the control strip 6 could easily snap and interfere with the insertion of the frame 21 in the cap 3, and this is bad for transmitting large torque.

The present invention is therefore intended to obviate or at least alleviate the problems encountered in prior art.

### SUMMARY OF INVENTION

It is the primary objective of the present invention to provide a screwdriver with a reliable torque transmission apparatus that can easily be assembled.

To achieve the foregoing objectives, the torque transmission apparatus includes a frame, a gear, four pawls and a shell. The frame includes a slot defined therein transversely, an aperture defined therein axially, and four cavities defined in an external side thereof. The slot is in communication with the aperture and the cavities. The gear includes a non-circular aperture axially defined therein and teeth formed on each of two opposite sides thereof. The gear is located in the slot. Each of the pawls is formed with at least one tooth and a block and located in a related one of the cavities. The shell is formed with two pushers on an internal side thereof and rotationally provided around the frame between two one-way modes. In each of the one-way modes, a related one of the pushers pushes the blocks of two related ones of the pawls to disengage the teeth of the two pawls from the teeth of the gear.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a screwdriver-used torque transmission apparatus in accordance with the first embodiment of the present invention;

FIG. 2 is an exploded view of the screwdriver-used torque transmission apparatus shown in FIG. 1;

FIG. 3 is an enlarged, partial, front view of the screwdriver-used torque transmission apparatus shown in FIG. 1;

FIG. 4 is a cross-sectional view of the screwdriver-used torque transmission apparatus shown in FIG. 1;

FIG. 5 is an enlarged, partial, cross-sectional view of the screwdriver-used torque transmission apparatus shown in FIG. 1, showing a first pair of pawls in a two-way mode;

FIG. 6 is another cross-sectional view of the screwdriver-used torque transmission apparatus shown in FIG. 5, showing a second pair of pawls in the two-way mode;

FIG. 7 is an enlarged, partial, cross-sectional view of the screwdriver-used torque transmission apparatus shown in FIG. 1, showing the first pair of pawls in a first one-way mode;

FIG. 8 is another cross-sectional view of the screwdriver-used torque transmission apparatus shown in FIG. 7, showing the second pair of pawls in the first one-way mode;

FIG. 9 is another cross-sectional view of the screwdriver-used torque transmission apparatus shown in FIG. 7;

FIG. 10 is an enlarged, partial, cross-sectional view of the screwdriver-used torque transmission apparatus shown in FIG. 1, showing the second pair of pawls in a second one-way mode;

FIG. 11 is another cross-sectional view of the screwdriver-used torque transmission apparatus shown in FIG. 10, showing the first pair of pawls in the second one-way mode;

FIG. 12 is a perspective view of a frame of a screwdriver-used torque transmission apparatus in accordance with the second embodiment of the present invention;

FIG. 13 is a side view of a screwdriver-used torque transmission apparatus according to the third embodiment of the present invention; and

FIG. 14 is a side view of a screwdriver-used torque transmission apparatus in accordance with the fourth embodiment of the present invention.

### DETAILED DESCRIPTION OF EMBODIMENTS

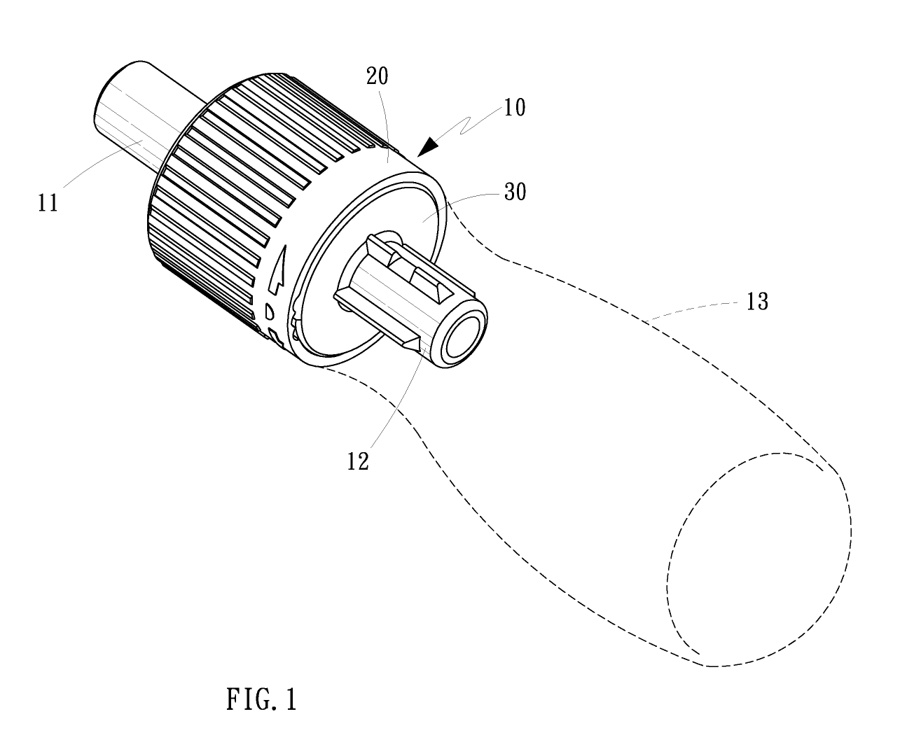

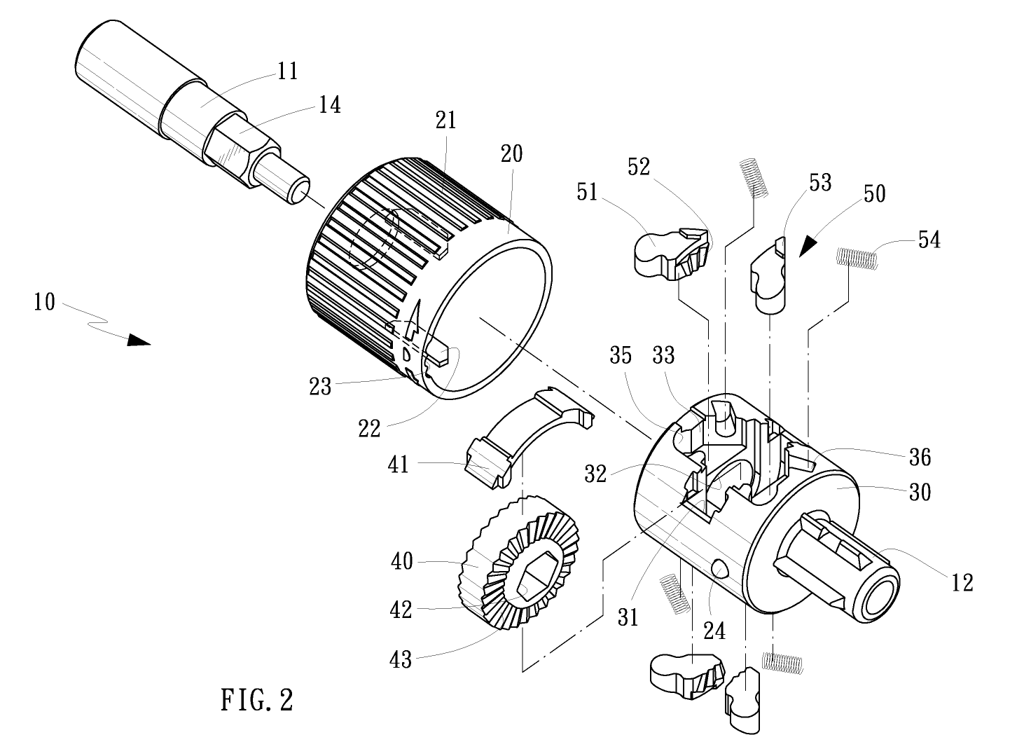

Referring to FIGS. 1 through 11, there is shown a screwdriver-used torque transmission apparatus 10 in accordance with a first embodiment of the present invention. The screwdriver-used torque transmission apparatus 10 includes a shaft 11, a shell 20, a frame 30, a gear 40, and two pairs of pawls 50 as shown in FIGS. 1 and 2.

The shaft 11 includes a non-circular cavity 15 axially defined in an end thereof and a non-circular shank 14 formed thereon near an opposite end thereof. The non-circular shank 14 is preferably a hexagonal shank. The non-circular cavity 15 is preferably a hexagonal cavity.

The shell 20 is a circular shell. The shell 20 includes ribs 21 extending on an external side thereof longitudinally, two pushers 22 formed on an internal side thereof, and three recesses 23 defined in the internal side thereof. The ribs 21 are used to increase friction thereof with a user's hand to facilitate the rotation of the shell 20. Each of the pushers 22 includes two chamfers formed thereof.

The frame 30 is a circular frame. The frame 30 includes a slot 31 defined therein transversely, an aperture 32 defined therein axially, two cavities 33 defined in a portion of the periphery thereof, and two cavities 34 defined in another portion of the periphery thereof. The slot 31 is in communication with the aperture 32. An open end of the slot 31 is in communication with the cavities 33 while an opposite open end of the slot 31 is in communication with the cavities 34. The aperture 32 is a circular one. The cavities 33 look like mirror images of each other. The cavities 34 look like mirror images of each other. Each of the cavities 33 and 34 includes a pivot-containing portion 35 and a spring-containing portion 36.

There is an insert 12 extending from an opposite end of the frame 30 axially. The insert 12 includes radial extensive portions extending from the periphery thereof.

There is used a detent 24. The detent 24 is in the form of a ball biased by a spring (not shown). The entire spring and a first portion of the detent 24 are located in a bore defined in the periphery of the frame 30. A second portion of the detent 24 is located outside the bore normally but can be withdrawn into the bore, against the spring.

The gear 40 includes a non-circular aperture 42 axially defined therein, teeth 43 formed on a side (or “end”) thereof, and teeth 43 formed on an opposite side (or “end”) thereof.

Each of the pawls 50 includes a pivot 51 formed thereon, at least one tooth 52 formed thereon, and a block 53 formed thereon. The pivot 51 is a rounded portion of the pawl 50. The tooth 52 is shaped corresponding to the teeth 43. The block 53 is shaped corresponding to the chamfers of the pushers 22.

In assembly, a handle 13 is formed around and on the insert 12 by injection molding of plastics for example. Because of the radial extensive portions, the insert 12 is securely inserted in the handle 13 so that the insert 12 can only be rotated together with the handle 13.

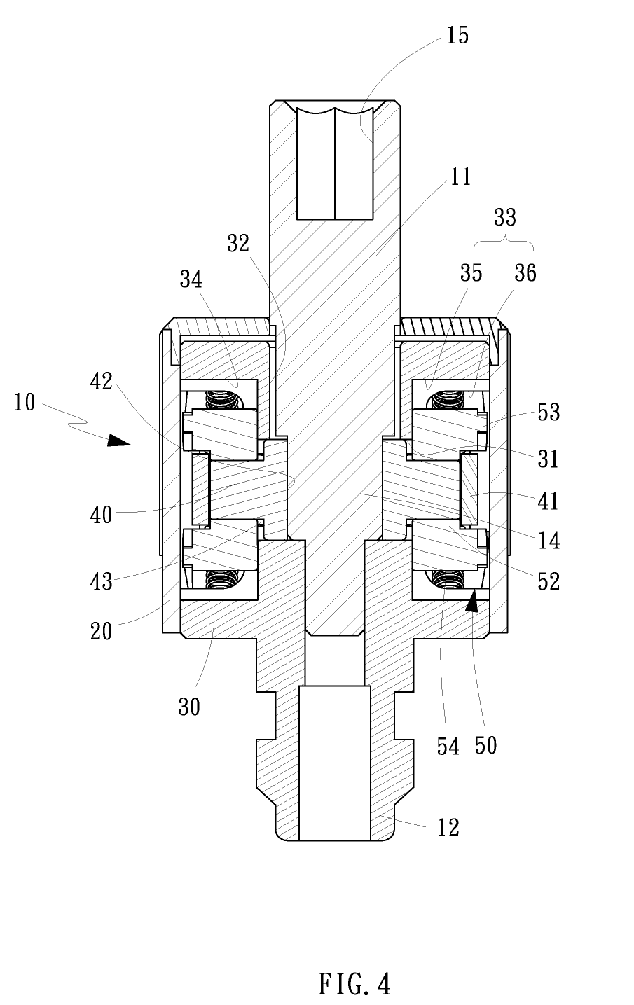

Referring to FIG. 4, the gear 40 is located in the slot 31. Then, the non-circular shank 14 is inserted in the non-circular aperture 42 through the aperture 32. Thus, the shaft 11 can only be rotated together with the gear 40.

The first pair of pawls 50 is located in the cavities 33, and the second pair of pawls 50 is located in the cavities 34. Now, the pivot 51 of each of the pawls 50 is pivotally located in the pivot-containing portion 35 of a related one of the cavities 33 and 34.

A spring 54 is located in the spring-containing portion 36 of each of the cavities 33 and 34. The spring 54 is preferably a compression spring. In each pair, the pawls 50 are biased by the springs 54 to engage the tooth 52 of each pawl 50 with the teeth 43 on a related side of the gear 40.

A first cover 41 is located in a first open end of the slot 31 so that the first cover 41 is in contact with the tooth 52 of each pawl 50 of the first pair. A second cover 41 is located in an opposite second open end of the slot 31 so that the second cover 41 is in contact with the tooth 52 of each pawl 50 of the second pair.

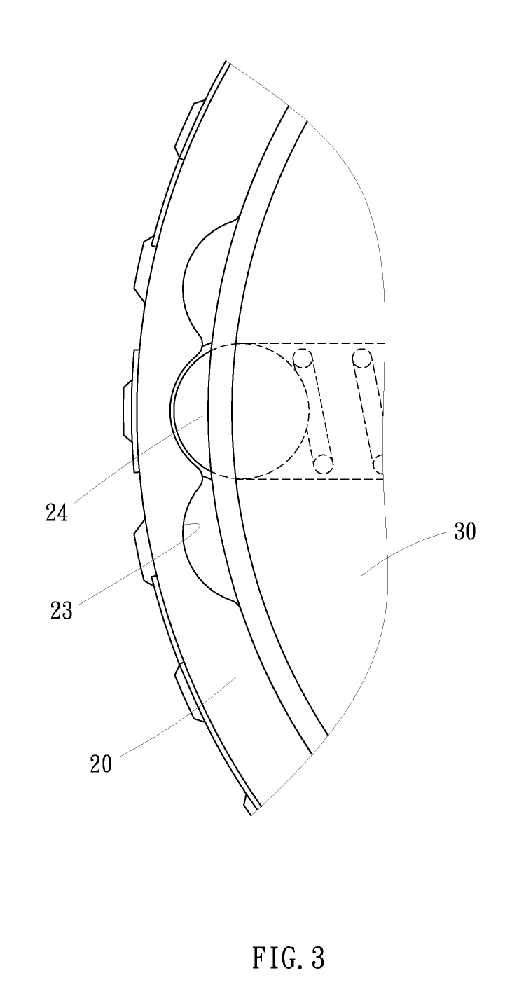

The shell 20 is provided on the frame 30. The first and second covers 41 are kept in the first and second open ends of the slot 31 by the shell 20. The first and second pairs of pawls 50 are kept in the cavities 33 and 34 by the covers 41. The gear 40 is kept in the slot 31 by the first and second pairs of pawls 50. The second portion of the detent 24 is located in a selected one of the recesses 23 of the shell 20 as shown in FIG. 3.

In use, the shell 20 can be rotated on the frame 30 to move the torque transmission apparatus 10 to a two-way mode. The torque transmission apparatus 10 is elastically retained in the two-way mode as the second portion of the detent 24 is located in the middle one of the recesses 23.

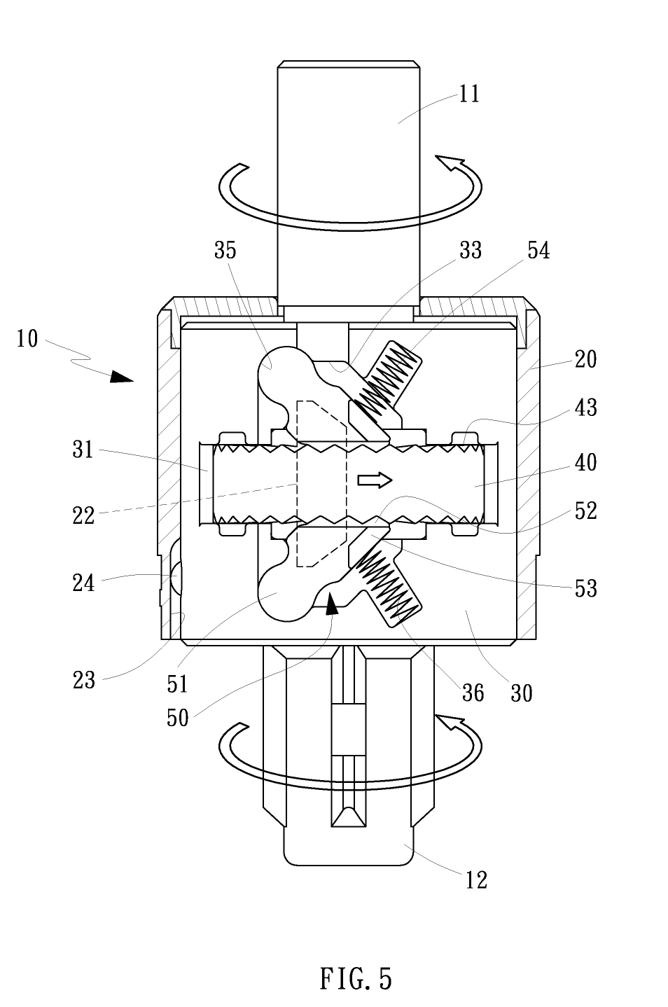

Referring to FIG. 5, the first pusher 22 is away from the blocks 53 of the pawls 50 in the first pair. Thus, the teeth 52 of the pawls 50 in the first pair are engaged with the teeth 43 on both sides of the gear 40.

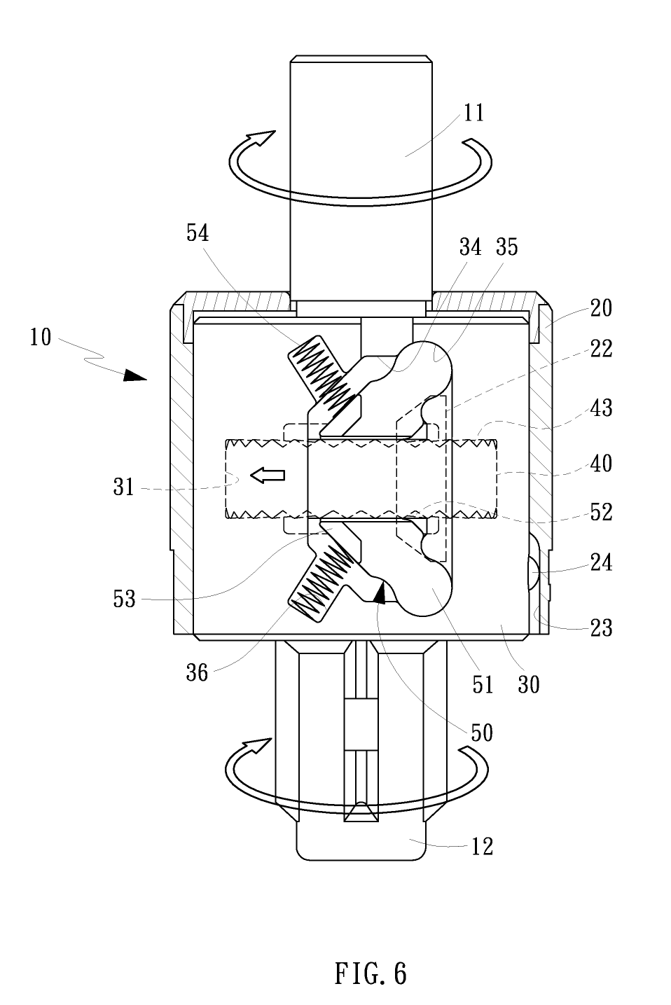

Referring to FIG. 6, the second pusher 22 is away from the blocks 53 of the pawls 50 in the second pair so that the teeth 52 of the pawls 50 in the second pair are disengaged from the teeth 43 on both sides of the gear 40.

Now, by rotating the insert 12 of the frame 30 clockwise as indicated by two arrow heads in solid lines in FIG. 5, the first pair of pawls 50 is rotated clockwise. The first pair of pawls 50 is engaged with the gear 40 so that the gear 40 is rotated clockwise by the first pair of pawls 50. The shaft 11 is rotated clockwise by the gear 40.

By rotating the insert 12 of the frame 30 counterclockwise as indicated by two arrow heads in solid lines in FIG. 6, the second pair of pawls 50 is rotated counterclockwise. The second pair of pawls 50 is engaged with the gear 40 so that the gear 40 is rotated counterclockwise by the second pair of pawls 50. The shaft 11 is rotated counterclockwise by the gear 40.

Alternatively, the shell 20 can be rotated on the frame 30 to move the torque transmission apparatus 10 to a first one-way mode. The torque transmission apparatus 10 is elastically retained in the first one-way mode as the second portion of the detent 24 is located in a first lateral one of the recesses 23.

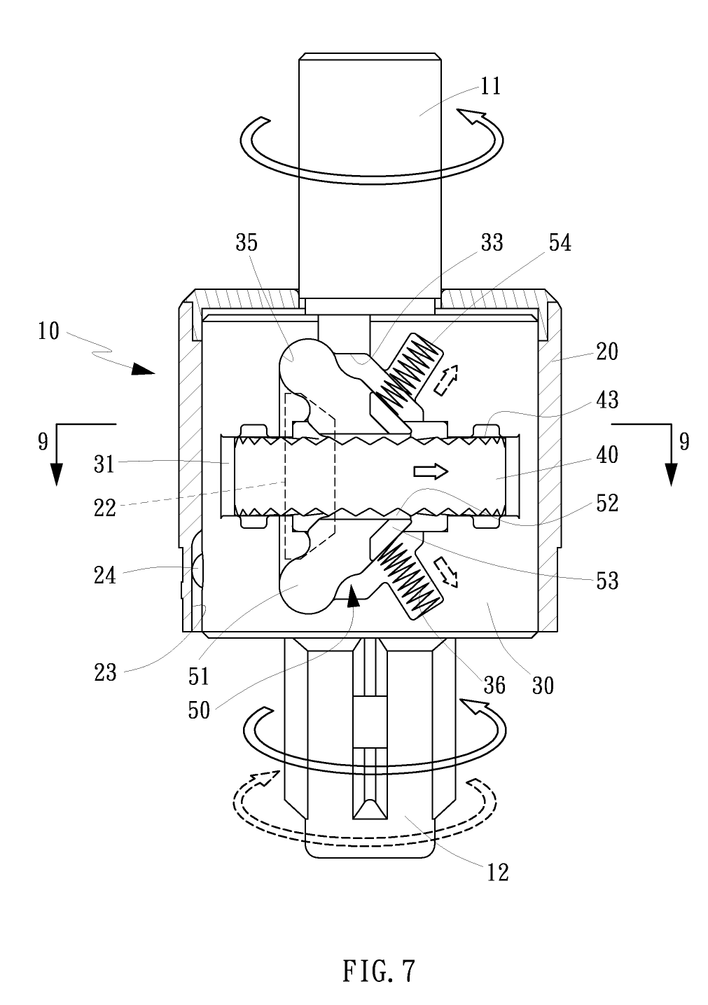

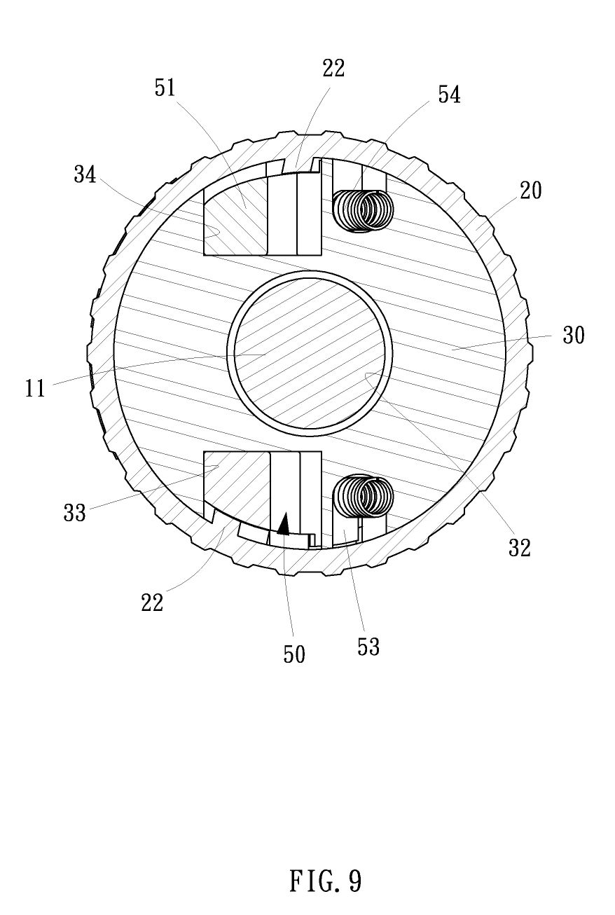

Referring to FIGS. 7 and 9, the first pusher 22 is moved away from the blocks 53 of the pawls 50 in the first pair. Thus, the teeth 52 of the pawls 50 in the first pair are engaged with the teeth 43 on both sides of the gear 40.

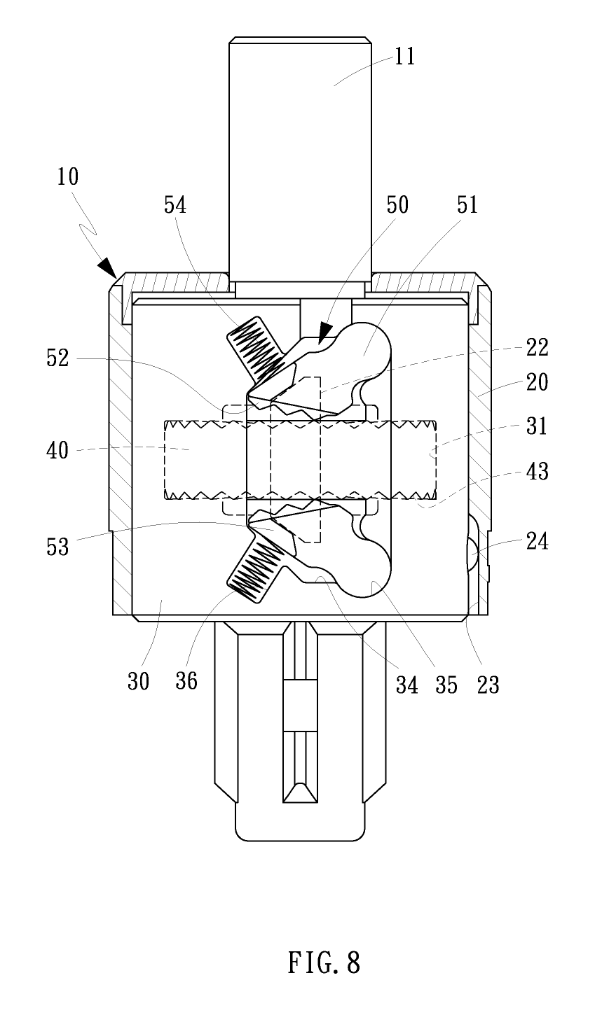

Referring to FIGS. 8 and 9, the blocks 53 of the pawls 50 in the second pair are pushed open by the second pusher 22 so that the teeth 52 of the pawls 50 in the second pair are disengaged from the teeth 43 on both sides of the gear 40.

Now, by rotating the insert 12 of the frame 30 clockwise as indicated by two arrow heads in solid lines, the first pair of pawls 50 is rotated clockwise. The first pair of pawls 50 is engaged with the gear 40 so that the gear 40 is rotated clockwise by the first pair of pawls 50. The shaft 11 is rotated clockwise by the gear 40 as indicated by arrow heads in solid lines.

By rotating the insert 12 of the frame 30 counterclockwise as indicated by an arrow head in phantom lines, the first pair of pawls 50 is rotated counterclockwise. The first pair of pawls 50 is disengaged from the gear 40 because of the elasticity of the springs 54. Thus, the gear 40 is not rotated counterclockwise by the first pair of pawls 50. Accordingly, the shaft 11 is not rotated counterclockwise by the gear 40.

Alternatively, the shell 20 can be rotated on the frame 30 to move the torque transmission apparatus 10 to a second one-way mode. The torque transmission apparatus 10 is elastically retained in the second one-way mode as the second portion of the detent 24 is located in a second lateral one of the recesses 23.

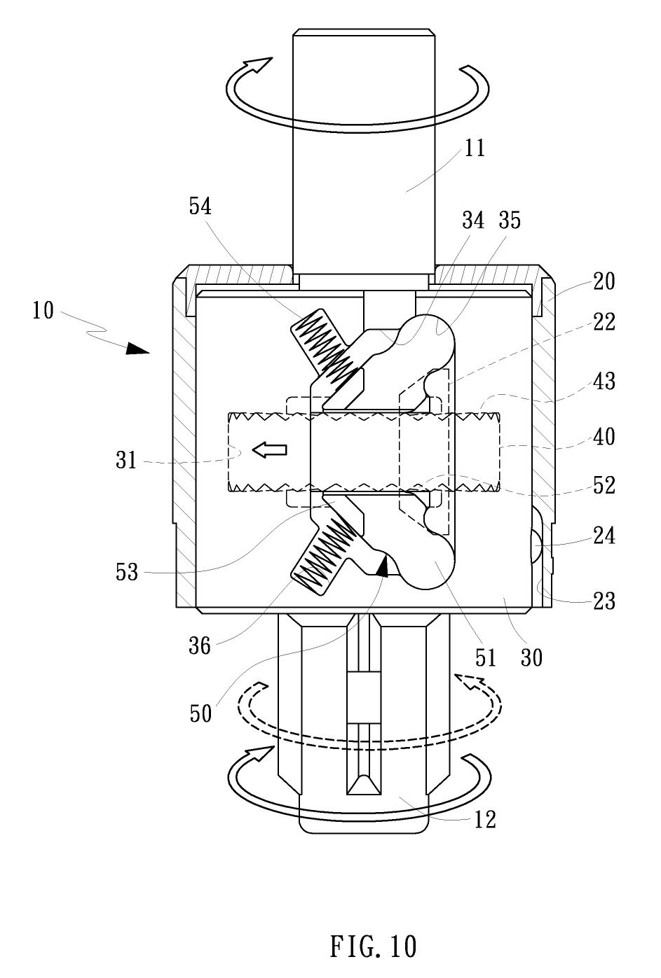

Referring to FIG. 10, the second pusher 22 is moved away from the blocks 53 of the pawls 50 in the second pair. Thus, the teeth 52 of the pawls 50 in the second pair are engaged with the teeth 43 on both sides of the gear 40.

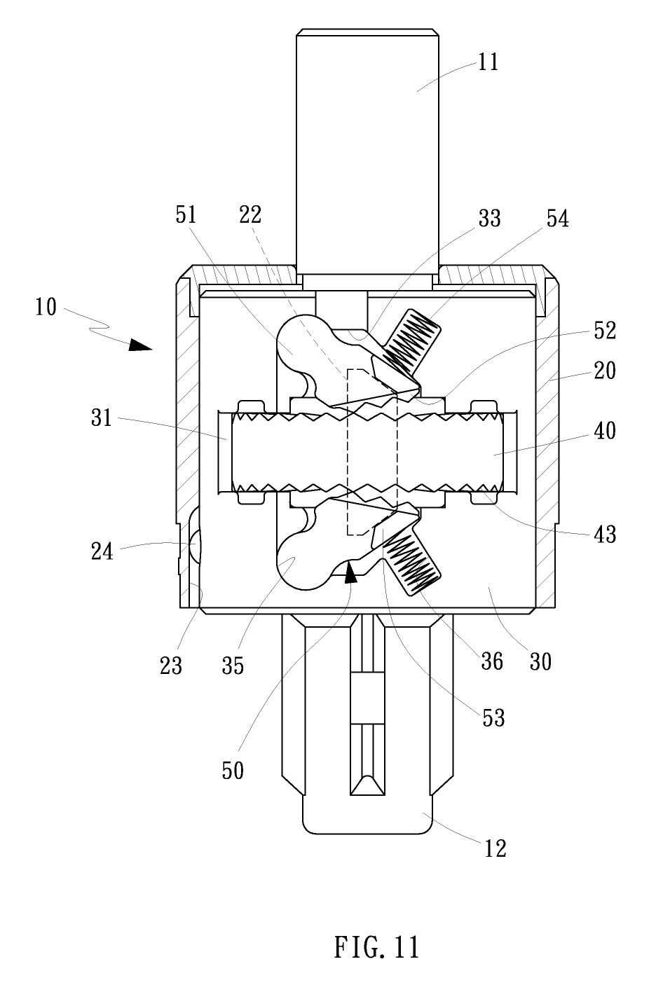

Referring to FIG. 11, on the other hand, the blocks 53 of the pawls 50 in the first pair is pushed open by the second pusher 22 so that the teeth 52 of the pawls 50 in the first pair are disengaged from the teeth 43 on both sides of the gear 40.

Now, by rotating the insert 12 of the frame 30 counterclockwise as indicated by two arrow heads in solid lines, the second pair of pawls 50 is rotated counterclockwise. The second pair of pawls 50 is engaged with the gear 40 so that the gear 40 is rotated counterclockwise by the second pair of pawls 50. The shaft 11 is rotated clockwise by the gear 40.

By rotating the insert 12 of the frame 30 clockwise as indicated by an arrow head in phantom lines, the second pair of pawls 50 is rotated clockwise. The second pair of pawls 50 is disengaged from the gear 40 because of the elasticity of the springs 54. Thus, the gear 40 is not rotated clockwise by the second pair of pawls 50. Accordingly, the shaft 11 is not rotated clockwise by the gear 40.

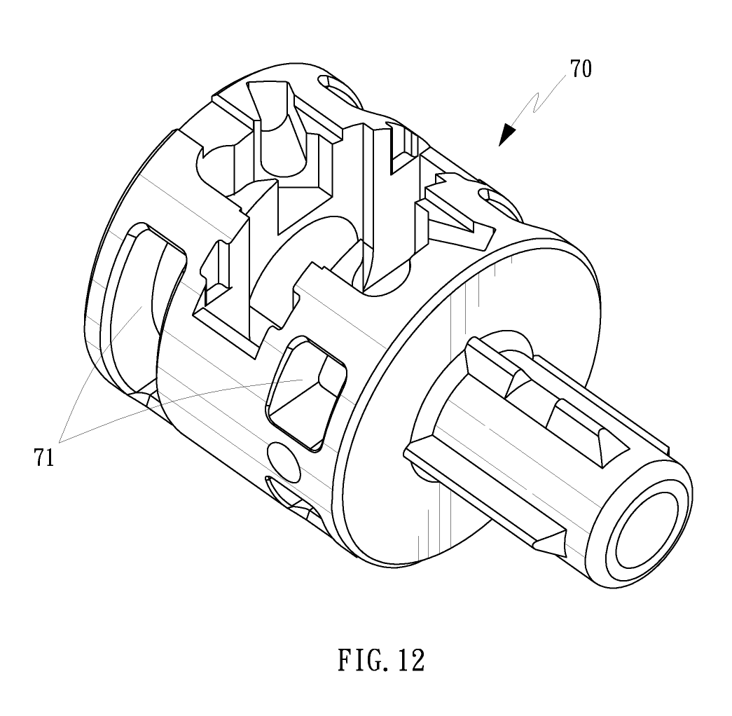

Referring to FIG. 12, there is shown a screwdriver-used torque transmission apparatus in accordance with a second embodiment of the present invention. The second embodiment is identical to the first embodiment except for including a frame 70 instead of the frame 30. The frame 70 is identical to the frame 30 except for including openings 71 defined therein to reduce the weight and cost thereof.

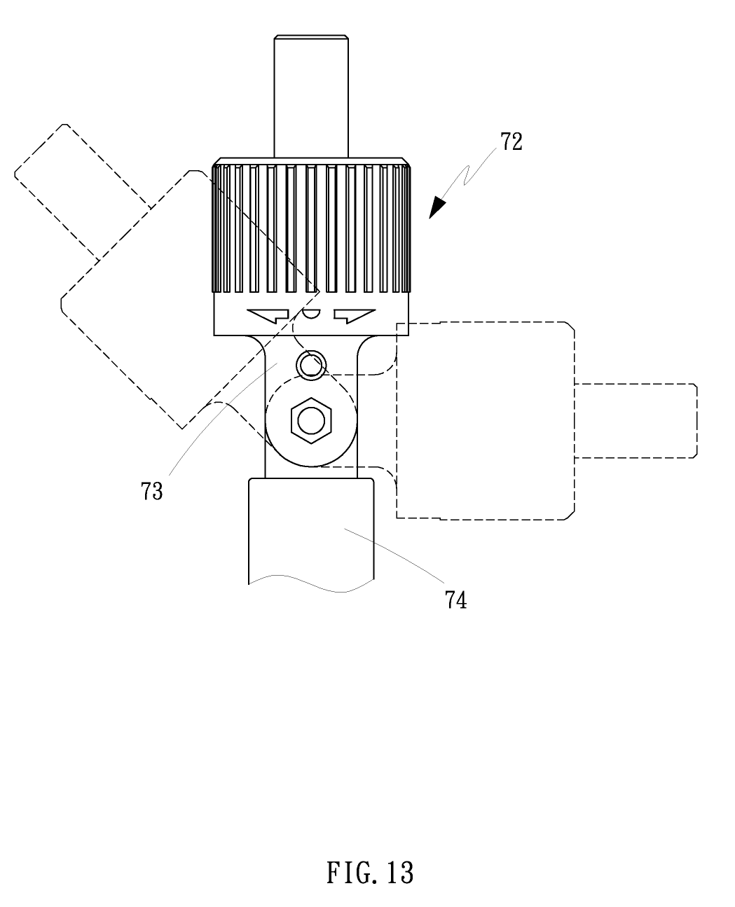

Referring to FIG. 13, there is shown a screwdriver-used torque transmission apparatus in accordance with a third embodiment of the present invention. The third embodiment is identical to the first embodiment except for including a frame 72 instead of the frame 30. The frame 72 is identical to the frame 30 except for including a connective section 73 instead of the insert 12. The connective section 73 of the frame 72 is pivotally connected to a handle 74.

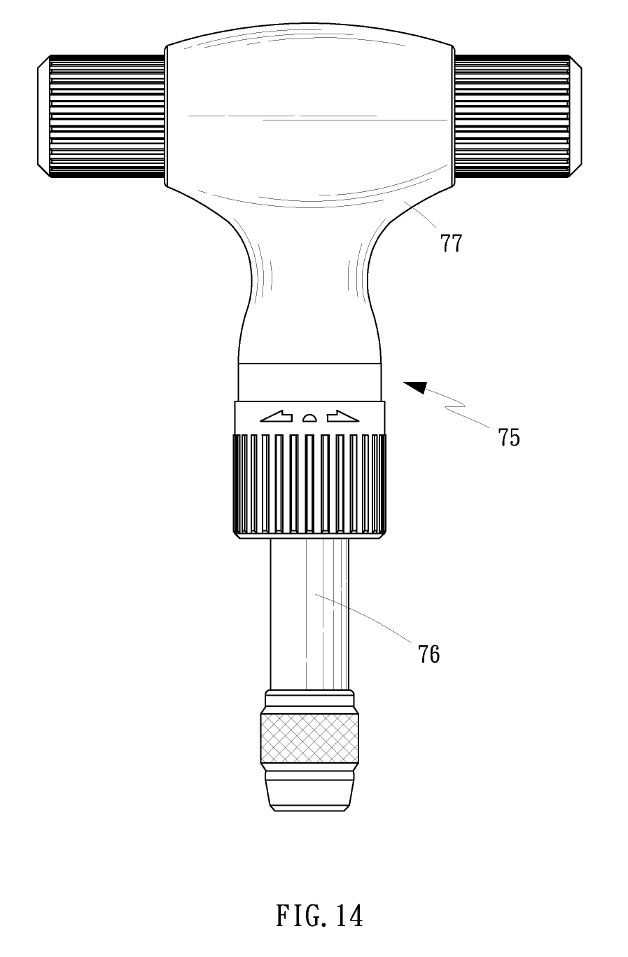

Referring to FIG. 14, there is shown a screwdriver-used torque transmission apparatus in accordance with a fourth embodiment of the present invention. The fourth embodiment is identical to the first embodiment except for including a frame 75 instead of the frame 30. The frame 75 is identical to the frame 30 except for including a T-shaped handle 77 instead of the insert 12. Moreover, a shaft 76 may be used instead of the shaft 11.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A screwdriver-used torque transmission apparatus including:
a frame including a slot defined therein transversely, an aperture defined therein axially, and four cavities defined in an external side thereof, wherein the slot is in communication with the aperture and the cavities;
a gear including a non-circular aperture axially defined therein and teeth formed on each of two opposite sides thereof, wherein the gear is located in the slot;
four pawls each formed with at least one tooth and a block and located in a related one of the cavities; and
a shell including two pushers formed on an internal side thereof, wherein the shell is rotationally provided around the frame between two one-way modes in each of which a related one of the pushers pushes the blocks of two related ones of the pawls to disengage the teeth of the two pawls from the teeth of the gear.

2. The screwdriver-used torque transmission apparatus in accordance with claim 1, including a spring-biased detent provided on the frame, wherein the shell includes two lateral recesses each for receiving the spring-biased detent as the shell is located in a related one of the one-way modes.

3. The screwdriver-used torque transmission apparatus in accordance with claim 1, including four springs for biasing the pawls to engagement with the gear.

4. The screwdriver-used torque transmission apparatus in accordance with claim 3, wherein each of the cavities includes a spring-containing portion for containing a related one of the springs.

5. The screwdriver-used torque transmission apparatus in accordance with claim 4, wherein each of the springs is a compression spring including an end located in the spring-containing portion of a related one of the cavities and another end in contact with a related one of the pawls.

6. The screwdriver-used torque transmission apparatus in accordance with claim 1, wherein each of the cavities includes a pivot-containing portion, wherein each of the pawls includes a pivot located in the pivot-containing portion of a related one of the cavities.

7. The screwdriver-used torque transmission apparatus in accordance with claim 1, wherein each of the pawls includes at least two teeth.

8. The screwdriver-used torque transmission apparatus in accordance with claim 1, including two covers each for closing an open end of the slot and guiding two related ones of the pawls.

9. The screwdriver-used torque transmission apparatus in accordance with claim 1, wherein the frame includes an insert extending from an end thereof opposite to the aperture.

10. The screwdriver-used torque transmission apparatus in accordance with claim 1, including a shaft formed with a non-circular shank inserted in the non-circular aperture of the gear.

11. The screwdriver-used torque transmission apparatus in accordance with claim 10, wherein the shaft includes a non-circular cavity axially defined therein.
